(19) United States
(12) Patent Application Publication
(10) Pub. No.: US 2021/0088711 A1
(43) Pub. Date: Mar. 25, 2021

(54) WEDGE LIGHTGUIDE

(71) Applicant: 3M INNOVATIVE PROPERTIES COMPANY, St. Paul, MN (US)

(72) Inventors: Nicholas A. JOHNSON, Burnsville, MN (US); Robert M. EMMONS, St. Paul, MN (US)

(21) Appl. No.: 17/040,316

(22) PCT Filed: Mar. 26, 2019
(86) PCT No.: PCT/IB2019/052440

§ 371 Date: Sep. 22, 2020

Related U.S. Application Data
(60) Provisional application No. 62/649,535, filed on Mar. 28, 2018.

(51) Int. Cl. F21V 8/00

(52) U.S. Cl. CPC G02B 6/0046; G02B 6/0016; G02B 6/0058; G02B 6/0036

(57) ABSTRACT

A display device including a light source and a wedge lightguide defining a light-inlet side, a display side, and a back side, the display and back sides facing in different directions and forming a wedge-shape that defines a convergence axis, the light-inlet side positioned at a divergent side of the wedge-shape and the back side facing away from a display surface of the display device. The back side includes a plurality of wedge extractors, each wedge extractor extending in a direction substantially orthogonal to the convergence axis. The light source positioned adjacent to the light-inlet side of the wedge lightguide. The wedge lightguide is configured to receive light rays from the light source through the light-inlet side and transmit the light rays through the display side an exit angle with a maximum intensity at between about 10° and about 40° measured from a plane defined by the display side.

### TECHNICAL FIELD

The present disclosure relates to lightguides and optical systems for optical display devices.

### BACKGROUND

Optical displays systems are widely used for lap-top computers, hand-held devices (e.g., smartphone), digital watches, automotive displays, and the like. The familiar liquid crystal display (LCD) is a common example of such an optical display. In the LCD display, portions of the liquid crystal have their optical state altered by the application of an electric field. This process generates the contrast necessary to display “pixels” of information. In some examples, the LCD displays may include combinations light sources and various optical films, including reflective polarizers, to produce and modify the light properties of the display assembly.

Optical displays can be classified based on the type of illumination. A common example of an optical display to incorporates a “backlight” wherein a light source is placed within the optical device and projects light through one or more optical layers (e.g., LCD panel) to illuminate the device. A typical backlight assembly includes an optical cavity and a lamp or other structure that generates light.

A variety of backlight assemblies have been proposed for illuminating optical displays. In some examples, the backlight assembly may incorporate the use of a lightguide. Lightguides generally work by receiving light from light sources and propagating the light within the lightguide until it is extracted from the lightguide and directed to a user passing through optical display devices such as an LCD assembly to illuminate an image that can be viewed by user. Efficient use, conservation, and distribution of the light is important for maximizing power efficiency, brightness, viewability, and heat dissipation in electronic displays such as those used in computer screens, smartphone or other personal devices, and automotive display systems.

### SUMMARY

In some examples, the disclosure describes a display device including a wedge lightguide defining a light-inlet side, a display side, and a back side, the display and back sides facing in different directions of each other to form a wedge-shape that defines a convergence axis, wherein the light-inlet side is positioned at a divergent side of the wedge-shape and the back side facing away from a display surface of the display device, wherein the back side includes a plurality of wedge extractors, and wherein each wedge extractor of the plurality of wedge extractors extends in a direction substantially orthogonal to the convergence axis, and a light source positioned adjacent to the light-inlet side of the wedge lightguide, wherein the wedge lightguide is configured to receive light rays from the light source through the light-inlet side and transmit the light rays through the display side, wherein the light rays transmitted through the display side define a maximum intensity at an exit angle between about 10° and about 40° measured from a plane defined by the display side.

In some examples, the disclosure describes a wedge lightguide including a light-inlet side defining a divergent side of the wedge lightguide, a convergent side opposite of the light-inlet side, a display side aligned substantially orthogonal to the light-inlet side, and a back side, wherein the display and back sides face in different directions of each other to form a wedge-shape that defines a convergence axis with the light-inlet side and the convergent side at opposite ends of the wedge-shape, wherein the back side includes a plurality of wedge extractors, and wherein each wedge extractor extends in a direction substantially orthogonal to the convergence axis, wherein the wedge lightguide is configured to receive light rays from a light source through the light-inlet side and transmit the light rays through the display side, wherein the light rays transmitted through the display side define a maximum intensity at an exit angle between about 10° and about 40° measured from a plane defined by the display side.

In some examples, the disclosure describes a wedge lightguide including an inlet-side coupler defining the light-inlet side that defines a divergent side of the wedge lightguide, wherein the inlet-side coupler is configured to increase a collimation angle of light entering through the light-inlet side, a convergent side opposite of the light-inlet side, a display side aligned substantially orthogonal to the light-inlet side and adjacent to the inlet side coupler, and a back side, wherein the display and back sides face in different directions of each other to form a wedge-shape that defines a convergence axis with the light-inlet side and the convergent side at opposite ends of the wedge-shape, wherein the back side includes a plurality of wedge extractors, and wherein each wedge extractor extends in a direction substantially orthogonal to the convergence axis, and wherein each wedge extractor of the plurality of wedge extractors includes an angled surface that defines an internal angle opposite the light-inlet side, wherein the internal angle is less than about 10°, wherein the wedge lightguide is configured to receive light rays from a light source through the light-inlet side and transmit the light rays through the display side, and wherein the light rays transmitted through the display side define a maximum intensity at an exit angle between about 10° and about 40° measured from a plane defined by the display side.

The details of one or more examples are set forth in the accompanying drawings and the description below. Other features, objects, and advantages will be apparent from the description and drawings, and from the claims.

### BRIEF DESCRIPTION OF THE FIGURES

FIG. 1 is a schematic side elevation cross-sectional of an example optical display system that includes a wedge lightguide as described herein.

FIG. 2 an enlarged schematic cross-sectional view of the wedge lightguide of FIG. 1 demonstrating some of the operational and optical principles of the wedge lightguide.

FIG. 3 is a schematic bottom view of the wedge lightguide and light source of FIG. 1.

FIG. 4 illustrates a schematic perspective view of the wedge lightguide of FIG. 1 with optional structured surfaces on both the light-inlet side and the display side.

FIG. 5 is a schematic side elevation cross-sectional view of another example optical display system that includes a light source, a wedge lightguide, and one or more optional optical films or devices.

FIG. 6 is an enlarged schematic cross-sectional view of the wedge lightguide of FIG. 5 demonstrating some of the operational and optical principles of the wedge lightguide.

FIG. 7 is a schematic bottom view of the wedge lightguide if FIG. 5 assembled adjacent to a light source.

FIG. 8 is a cross-sectional view of a wedge light used in the modeling experiments of Example 1 that defines the various dimensions of the components used in the modeling.

FIG. 9 shows the distil loss fraction for the wedge lightguide of the examples compared to a comparable plane lightguide for wedge extractors modeled at various ramp internal angles.

FIG. 10 shows a ratio of the illuminance to maximum luminance of the wedge lightguide of the examples compared to a comparable plane lightguide for wedge extractors modeled at various ramp internal angles.

FIG. 11 shows the relative brightness values (of the wedge lightguide of the examples compared to a comparable plane lightguide for wedge extractors modeled at various ramp internal angles.

### DETAILED DESCRIPTION

Automotive displays and other high-brightness optical systems often use light emitting diode (LEDs) as a light source for such optical display systems due to brightness requirements. Such LEDs may be relatively large compared to the light sources used in other portable devices such as laptop computers and cell phones. As a result, the lightguides used in such systems are relatively thick (e.g., more than 1.5 mm thick) in order to efficiently capture light from the LED light sources. However, as the thickness of a respective lightguide increases, the coupling efficiency (e.g., the ability of the lightguide to efficiently extract and redirect propagating light rays within the guide) will generally decrease. For example, the relatively large thickness of the lightguide materials corresponds to an increase in the down-guide travel distance for a respective ray propagating within the lightguide for a given propagation angle. Accordingly, light rays propagating within a relatively thick lightguide will have fewer interactions (e.g., reflections) per unit of length traveled compared to light rays propagating at the same propagation angle within a comparatively thin lightguide.

In some examples, the disclosure describes a wedge-shaped lightguide (e.g., “wedge lightguide”) that may be incorporated in optical display systems and devices such as automotive displays having high brightness demands. The wedge lightguides described herein may be relatively thick (e.g., thickness greater than 1.5 mm) and configured to receive light from a light source such as a LEDs and redirect the light efficiently and relatively uniformly across a display side surface wherein the exiting light continues in a generally lateral direction relative to the display surface of the device. In some examples, the light exiting the wedge lightguide through the display side of the wedge lightguide may be collimated within a specified collimation angle and directed in a direction generally parallel to an optical display surface (e.g., perpendicular to the normal of the optical display surface). The wedge lightguides described herein may include one or more structured surfaces that modify and redirect light passing through the lightguide to produce highly uniform, relatively collimated exiting light with a higher degree of extraction efficiency compared to traditional lightguides.

Additionally, or alternatively, in some examples, by directing the outputted light in a direction generally parallel to an optical display surface as opposed directing the light toward a viewer, the wedge lightguides described herein, may provide a universal, versatile, and highly efficient backlight system that may be used in conjunction with a variety of turning films or other specialty films/devices designed to create distinct viewing patterns without needing additional modification of the lightguide or light source to accommodate such films.

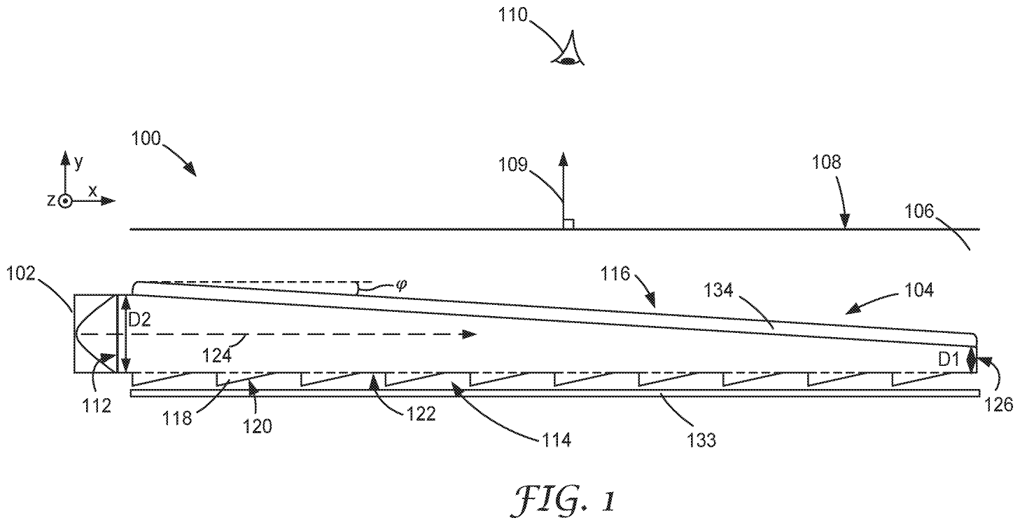

FIG. 1 is a schematic side elevation cross-sectional view of an example optical display system 100 that includes a light source 102, a wedge lightguide 104, as well as one or more optional optical films or devices 106. Optical display system 100 may define a display surface 108 having a normal 109 oriented towards a viewer 110. For ease of description, optical display system 100 and it various components are shown and described in referent to the x, y, and z-axes noted in FIG. 1 and used consistently throughout the FIGS. 1-4.

Wedge lightguide 104 includes a light-inlet side 112, a back side 114, and a display side 116. Back side 114 may include plurality of wedge extractors 118 disposed across major surface 122, with each wedge extractor 118 defining an angled surface 120. Display side 116 may represent the side of wedge lightguide 104 generally facing display surface 108 while back side 114 may represent the side of wedge lightguide 104 generally facing away from display surface 108. Display side 116 may be characterized as the light-outlet side where the majority of the light entering through light-inlet side 112 will be transmitted out of wedge lightguide 104.

For purposes of describing and understanding, the orientation of a given side of wedge lightguide 104 may be characterized in terms of the plane defined by the side, regardless of the orientation or shape of any individual surface structure (e.g., prisms, wedges, lenticulars, diffusers, or the like) that may or may not be present on the respective side. For example, as described further below, back side 114 may include a plurality surface structures in the form of wedge extractors 118 that define a plurality of angled surfaces 120. The various faces of wedge extractors 118 and major surface 122 of back side 114 may be oriented in a variety of directions. Despite the presence of wedge extractors 118 or the orientation any of the respectful surfaces, back side 114 may be characterized as defining a plane that extends in x-z plane of FIG. 1 and faces in the negative y-axis direction (e.g., the normal of the plane defined by back side 114 points in the negative y-axis direction). The description of a given side facing, pointing, positioned, or oriented in a particular direction as used throughout the description refers to the orientation of the plane defined by the respective side rather that the orientation of any given optical structure on the respective side unless described otherwise. Thus, referring to FIG. 1, light-inlet side 112 may be characterized as defining a plane set substantially orthogonal (e.g., orthogonal or nearly orthogonal) to display surface 108, back side 114 may be characterized as defining a plane set substantially parallel (e.g., parallel or nearly parallel) to display surface 108 but facing in the opposite direction to display surface 108, and to display side 114 may be characterized as defining a plane that is offset from display surface 108 by a convergence angle (φ). Additionally, or alternatively, light-inlet side 112 may be characterized as being substantially orthogonal (e.g., orthogonal or nearly orthogonal) to back side 114. While, back side 114 is illustrated and described in FIG. 1 as being substantially parallel to display surface 108, in other examples, wedge lightguide 104 may be oriented in display system 100 such that display side 116 is substantially parallel (e.g., parallel or nearly parallel) to display surface 108 with light exiting from display side 116 in a lateral direction relative to display surface 108.

Display side 116 and back side 114 may be positioned generally opposite of one another such that the two sides face in different directions of each other and aligned at a non-parallel, convergence angle (φ) to one another such that the two sides form a wedge-shape. In some examples, convergence angle (φ) may be referred to as the wedge angle, taper angle, or the like for wedge lightguide 104. In some examples, the taper of the wedge-shape may also be characterized by the ratio of thicknesses between display side 116 and back side 114 measured at convergent side (D1) 126 and adjacent to light-inlet side (D2). In some examples the ratio of thicknesses (D1:D2) may be less than about 0.9, less than about 0.5, or less than about 0.25.

For purposes of this description, the wedge-shape of wedge lightguide 104 may be characterized by its convergence axis 124, which may be characterized as the direction established by the taper between display and back sides 114 and 116 moving from the divergent side (e.g., light-inlet side 112) to the convergent side 126 of the wedge-shape, parallel to the plane defined by back side 114. In FIG. 1, convergence axis 124 is illustrated as being aligned parallel to the x-axis and the plane of back side 114. Each wedge extractor 118 on back side 114 may extend in a direction substantially orthogonal (e.g., orthogonal or nearly orthogonal apart for minor misalignments (e.g., ±5°) resulting during the manufacturing process that do not significantly modify the optical characteristics of the wedge extractors) to convergence axis 124.

Optical system 100 may be configured such that light produced by light source 102 enters wedge lightguide 104 through light-inlet surface 112 where it propagates in the general direction of convergence axis 124. In some examples, wedge lightguide 104 may define an index of refraction higher than the material directly adjacent to display side 116 (e.g., air or other optical film), thereby causing any light rays propagating within wedge lightguide 104 to either be reflected by the various sides of the lightguide or preferentially refracted by display side 116. As described further below, the parameters including the various surface structures of wedge lightguide 104 may be configured such that light exiting through display side 116 may be substantially collimated within a specified collimation exit angle that defines a maximum intensity exit angle (e.g., the point within the maximum intensity of the outputted light occurs) between about 10° and about 40° measured from the plane defined by back side 114 relative to convergent axis 124 (e.g., the angle measured in the x-y plane with the x-axis representing 0°). The bounds of the collimation exit angle may be determined as the point where the intensity of the exiting light rays diminishes to less than 10% of the maximum intensity. In some examples, the exit collimation angle and may be between about 0° to about 50° where 0° represents the convergence axis 124 or the x-axis (e.g., a collimation angle between about 40° to about 90° relative to normal 109 of display surface 108 where 0° represents normal 109). In some examples, the peak intensity exit angle for light exiting display side 116 may be between about 10° and about 25° measured relative to convergence axis 124 (e.g., between about 65° to about 80° relative to normal 109 of display surface 108 where 0° represents normal 109). In some examples, the exiting light rays may be substantially collimated within a collimation angle of less than about ±25°.

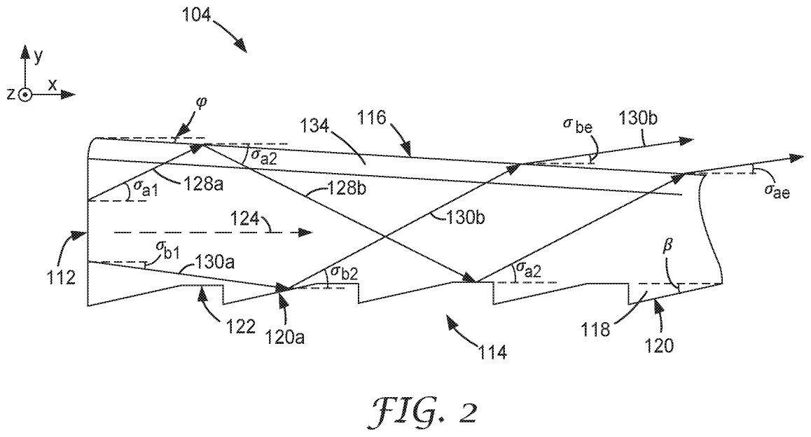

Whether a given light ray within wedge lightguide 104 will be reflected or refracted by a given side will depended on the angle of propagation (σ) for the light ray. FIG. 2 is an enlarged schematic cross-sectional view of wedge lightguide 104 demonstrating some of the operational and optical principles of wedge lightguide 104. As shown in FIG. 2, light rays 128, 130 may be produced by light source 102 and introduced into wedge lightguide 104 through light-inlet side 112 where the light rays 128, 130 progress down-guide with an initial propagation angle of σₐ₁ and σ_{b1} respectively. The initial propagation angles σₐ₁ and σ_{b1}, as well as the other propagation angles and/or exit angles within wedge lightguide 104 may be measured in reference to convergence axis 124 and normal 109 and (e.g., within the x-y plane in FIGS. 1 and 2) where convergence axis 124 is taken as 0°. For ease of understanding, the propagation angles of the respective light rays 128, and 130 are described in terms of their absolute values relative to convergence axis 124.

Due to the optical properties of wedge lightguide 104 and display system 100, light rays propagating within wedge lightguide 104 will be substantially reflected by display side 116 and back side 114, provided the propagation angle of the light ray is below some specified threshold angle (σₜ). Light rays exceeding the threshold angle (σₜ) that become incident on display side 116 will be substantially refracted, rather than reflected, and exit display side 116 at an exit angle (e.g., σₐₑ and σ_{be}).

Due to the geometry and surface structures of wedge lightguide 104, the propagation angle (σ) of the light rays propagating within wedge lightguide 104 will progressively increase depending on the surface reflecting the light ray or the number of reflections that occur. For example, light ray 128a entering through light-inlet side 112 at an entrance/propagation angle σₐ₁ (relative to the x-axis) less than σₜ and directed toward display side 116 will be substantially reflected by display side 116 toward back side 114. Due to the convergence angle (φ) between display side 116 and back side 114, the light ray 128b reflected by display side 116 will propagate at an angle σₐ₂ (relative to the x-axis) that is approximately equal to the absolute values of σₐ₁+2φ. Light ray 128b will then continue toward back side 114 where it is shown as being reflected by major surface 122 (as opposed to a surface of one of wedged shaped extractors 118) where the ray is reflected back toward display side 116 as reflected ray 128c retaining the propagation angle σₐ₂. Provided the propagation angle σₐ₂ of reflected ray 128c exceeds the threshold angle (σₜ) the light ray will be substantially refracted, rather than reflected, and exit display side 116 as exiting ray 128d at an exit angle of σₐₑ.

In this arrangement, it can be appreciated that light rays entering through light-inlet side 112 at a propagation angle exceeding threshold angle (σₜ) will exit through display side 116 at a position closer to light-inlet side 112 and light source 102, while light entering and traveling at a propagation angle (σ) below the threshold angle (σₜ) will require additional reflections and therefore exit further down-guide (e.g., closer to convergent side 126). Thus, the wedge-shape geometry between display side 116 and back side 114 may provide a better extraction and distribution of exiting light across the entire surface of display side 116 compared to a plane lightguide.

Even with the wedge-shape geometry of wedge light guide 104, the relatively large thickness of wedge lightguide 104 (e.g., greater than 1.5 mm) will cause light rays propagating within wedge lightguide 104 will have few interactions (e.g., reflections) per unit of length traveled relative to convergence axis 124. Accordingly, the relatively large thickness of wedge-lightguide 104 will lower extraction efficiency of the lightguide compared to a comparable wedge lightguide of a lower thickness.

In some examples, to improve the extraction efficiency for light exiting through display side 116, particularly light exiting down-guide or closer to convergent side 126, back side 114 may include a plurality of wedge extractors 118 that each include a respective angled surface 120 configured to both reflect propagating light rays as well as increase the propagation angle (σ) of the reflected ray. For example, each angled surface 120 may define an internal angle β relative the plane defined by back side 114 (e.g., relative to major surface 122). The internal angle β may be established by the side of angled surface 120 opposite of light source 102 and light-inlet side 112 (e.g., the side further down-guide). The propagation angle σ of light rays reflecting off a given angled surface 120 will be increased by approximately the amount of two times internal angle β. As one non-limiting example, FIG. 2 illustrates light ray 130a entering through light-inlet side 112 at propagation angle σ_{b1} and directed toward back side 114. Light ray 130a is reflected by angled surface 120a as reflected ray 130b having a propagation angle σ_{b2} (relative to the x-axis) equal to approximately the absolute values of σ_{b1}+2β. If the propagation angle σ_{b2} of reflected ray 130b exceeds the threshold angle (σₜ), the ray will be substantially refracted, rather than reflected, by display side 116 and exit wedge lightguide 104 as exiting light ray 130c with an exit angle of σ_{be}.

Wedge extractors 118 may take on any suitable shape and design provided wedge extractors 118 define at least one angled surface 120 that operates as the primary reflective surface and defines an internal angle β relative the plane defined by back side 114. Angled surface 120 may be planer, curved, undulated, segmented, or a combination thereof. In some examples, wedge extractors 118 may described as discrete prisms (e.g., microprisms) on back side 114 or may have be established by an undulated pattern (e.g., a surface creating an undulated saw-toothed or sinusoidal pattern) imprinted across back side 114.

Internal angle β may be set so that light rays reflected by angled surface 120 are redirected toward display side 116 possessing a propagation angle (σ) sufficient to allow the reflected light ray to be at least partially refracted and exit wedge lightguide 104 within a specified exit collimation angle. In some examples, to obtain an exit collimation angle between about 0° to about 50° for the exiting light rays, where 0° represents the x-axis, the internal angle β of wedge extractors 118 may be greater than 0°, but less than about 10° measured relative to the plane defined by back side 114 or major surface 122, where the internal angle β represents the side of angled surface 120 further from light source 102 (e.g., the side more down-guide in the x-axis direction). In some examples, having relatively low angle extractors (e.g., β less than about 10°) compared to higher angle extractors (e.g., β greater than 10°) may help lower the down-guide angular distributions of the exiting light rays allowing the exiting light to maintain a relatively uniform collimation angle. The uniform collimation of exiting light rays the may be particularly useful in display systems that further process the light (e.g., via a subsequent turning film) where the uniformity is needed to maintain optical uniformity. In some examples, the internal angle β may be between about 0.5° to about 10°, between about 1° to about 8°, or between about 1° to about 5°.

In some examples, the internal angle β of wedge extractors 118 may define an angle gradient in the direction of convergence axis 124 (moving distal or down-guide). For example, the internal angle β or wedge extractors 118 may increase the further down-guide a given extractor is from light source 102. Such a configuration may provide a more uniform exit collimation angle of light exiting across display side 116 as well as a greater extraction efficiency further down-guide. For example, the amount of light that propagates further down-guide (e.g., towards convergence side 126) may be less and may exhibit, at least initially, a propagation angle (σ) much lower and closer to 0° (e.g., closer to parallel with convergence axis 124). Thus, light reflecting off an angled surface 120 more distal (e.g., down-guide) to light-inlet side 112 may require a greater change in its propagation angle (σ) in order capture light that exceeds the threshold angle σₜ, which may be accomplished by increasing the internal angle β for the more distal wedge extractors 118.

Additionally, or alternatively, the size and placement of wedge extractors 118 may be selectively varied over back side 114 to enhance the extraction efficiency of the propagating light rays down-guide. For example, light entering light-inlet side 112 may exhibit a particular dispersal pattern depending on the type of light source 102. Depending on the dispersal pattern, the amount of light that is turned or reflected up-guide or down-guide may be improved by either increasing or decreasing the available surface area or internal angle β of wedge extractors 118 in areas where an increase or decrease in the extraction efficiency is desired. In some examples, an increased presence of wedge extractors 118 (e.g., available surface area) within the distal regions of wedge lightguide 104 may help increase the efficiency of light extracted through display side 116 within these distal regions by increasing the propagation angle (σ) of the reflected light such that it can be substantially refracted and exit through display side 116.

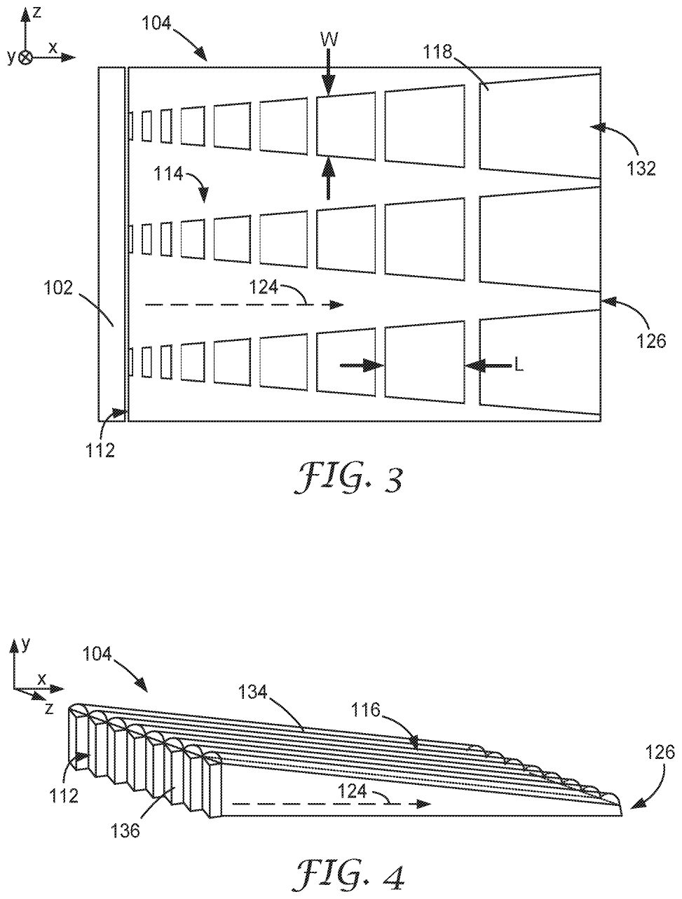

FIG. 3 illustrates one non-limiting example of how wedge extractors 118 may be distributed across back side 114. FIG. 3 is a schematic bottom view of wedge lightguide 104 assembled adjacent to light source 102 (e.g., similar arrangement to display system 100). Wedge extractors 118 may be arranged in one or more groupings 132 that extend from the proximal region (e.g., adjacent light-inlet side 112) to the distal region (e.g., adjacent convergent side 126) of back side 114. Each wedge extractor 118 within a group 132 may define a width (W) between about 5 μm to about 400 μm. In some examples, the widths of wedge extractors 118 within a respective group 132 may be different such that wedge extractors 118 within the proximal region of the wedge lightguide 104 (e.g., closer to light-inlet side 112) possess a smaller width compared to wedge extractors 118 within the distal region of the wedge lightguide 104 (e.g., closer to convergent side 126). In some such examples, wedge extractors 118 within a given grouping 132 may define a range of widths that extends from about 10 μm to about 150 μm. Additionally, or alternatively, the range of widths may define a width gradient such that the widths of wedge extractors 118 increase (e.g., continuously or step-wise increase) the more distal (e.g., down-guide) a given wedge extractor 118 is from light-inlet side 112.

Additionally, or alternatively, the respective down-guide lengths (L) (not drawn to scale) of wedge extractors 118 as measured in the direction of convergence axis 124, may increase within a respective grouping 134 the further a wedge extractor 118 is from light-inlet side 112. In some examples, the length (L) of wedge extractors 118 may be adjusted by increasing the height/depth of a give wedge extractor 118 from major surface 122 measured relative to the y-axis direction) moving distal (e.g., down-guide) from light inlet-side 112 with the internal angle β remaining relatively constant. In some such examples, wedge extractors 118 within a given grouping 132 may define a range of depths that extends from about 0.5 μm to about 10 μm with the larger depths providing larger extractor lengths (L). Additionally, or alternatively, the range of depths may define a depth gradient such that the respective depths of wedge extractors 118 increase (e.g., continuously or step-wise increase) the more distal (e.g., down-guide) a given wedge extractor 118 is from light-inlet side 112. In some example, the respective surface areas of angled surfaces 120 may increase (increasing in width, length, or both) the more distal (e.g., down-guide) a given wedge extractor 118 is from light-inlet side 112. For example, wedge extractors 118 may include a first and second wedge extractor, wherein the first wedge extractor is positioned closer to light-inlet side 112 than the second wedge extractor. The first wedge extractor may define width, depth, length, or surface area that is less than the respective width, depth, length, or surface of the second wedge extractor. In some examples, depending on the internal angle β and selected depth, the length (L) of wedge extractors 118 may be between about 0.01 mm to about 0.4 mm or between about 0.02 mm to about 0.2 mm.

The number of groups 132 of wedge extractors 118 may be selected to provide the desired optical properties for wedge lightguide 104. In some examples, the uniformity and disbursement of the light extracted through display side 116 may be improved by including more groups 132 of wedge extractors 118 with smaller respective widths. In some examples, wedge lightguide 104 may include about 25 to about 200 groups 132 of wedge extractors per centimeter measured laterally across back side 114 (e.g., in the z-axis direction of FIG. 3).

As described further below, the combination of the wedge-shape of wedge lightguide 104 and wedge extractors 118 may provide a greater extraction efficiency for transmitting light through display side 116. The combination of features may be particularly useful for certain types of applications, such as automotive displays, that utilize or require relatively thick lightguides (e.g., thickness as measured in the y-axis direction) on the order of about 2 mm to about 3 mm, which may otherwise suffer from decreased extraction efficiency due to the relative thickness of the lightguides.

In some examples, display system 100 may include a light reflector 133 (FIG. 1) positioned adjacent to back side 114. Light reflector 133 may be configured to reflect light exiting through back side 114 back into wedge lightguide 104 to increase the extraction efficiency of wedge lightguide 104. Additionally, or alternatively, back side 114 may include a reflective coating (e.g., a mirrored finish) configured to substantially reflect light that may otherwise exit through back side 114.

To improve the disbursement of light within the lateral direction (e.g., within the y-z plane), display side 116 may itself be a structured surface. For example, display side may include a plurality of microstructure 134 such as lenticular microstructures, configured to increase the lateral collimation angle (e.g., angle relative to the y-z plane of FIG. 1) of the light rays exiting thorough display side 116.

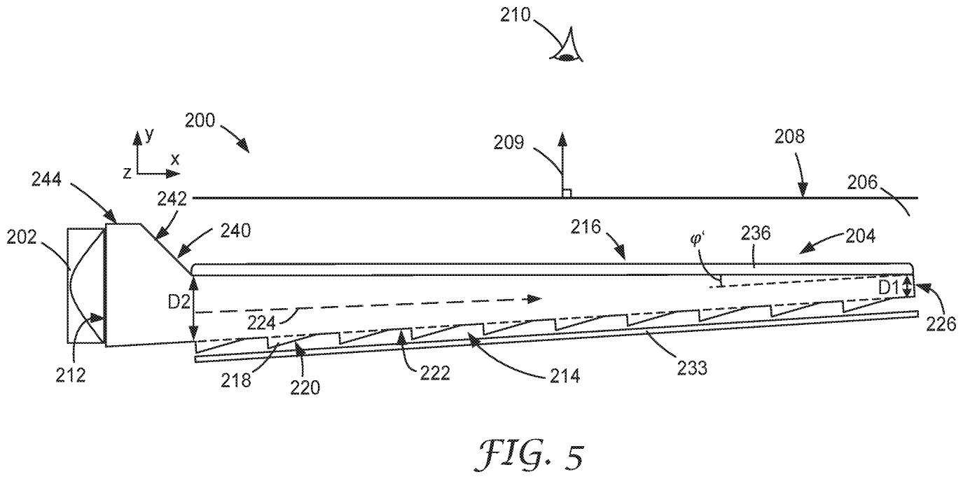

FIG. 4 is a schematic perspective view of wedge lightguide 104 with optional structured surfaces on both light-inlet side 112 and display side 116. As shown in FIG. 4, a plurality of lenticular microstructures 134 may be generally aligned with respect to convergence axis 124 such that the microstructures extend from light-inlet side 112 to convergent side 126. In some examples, plurality of lenticular microstructures 134 may be offset by about ±10° relative to convergence axis 124 where 0° represents a parallel alignment with convergence axis 124.

Additionally, or alternatively, to improve the distribution of light exiting through display side 116 within the lateral direction (e.g., within the x-z plane), light-inlet side 112 may include a plurality of microstructures configured to spread or distribute light in the x-z plane as the light enters through light-inlet side 112. For example, light-inlet side 112 may include a plurality of microstructures 136 such as lenticular microstructures, prisms, or the like, aligned substantially vertically (e.g., aligned within ±5° of the y-axis of FIG. 4) to increase the distribution or spread of the light within the x-z plane propagating within wedge lightguide 104. In some examples, microstructures 136 may both disperse (e.g., spread along z-axis) as well as collimate the entering light within a desired collimation angle relative the plane defined by back side 114 (e.g., relative to the x-z plane).

Additionally, or alternatively, light-inlet side 112 may include a structure configured to spread or diverge the incoming light relative to the x-y plane. By spreading light in such a way, a greater percentage of light may be passed through display side 116 near or adjacent to light source 102 to help uniformly distribute the light exiting through display side 116.

Wedge lightguide 104 including any surface structures such as wedge extractors 118, microstructures 134 of display side 116, or microstructures 136 of light-inlet side 112 may be fabricated from a wide variety of optically suitable materials including, for example, polycarbonate; polyacrylates such as polymethyl methacrylate; polystyrene; polyethylene terephthalate; polyethylene naphthalate; copolymers or blends of the same; glass; or the like. In some examples, the material selected may be optically transparent or have low haze and high clarity to avoid undesirably scattering incident and propagating light. In some examples, wedge lightguide 104 may have a sufficiently high index of refraction, such as about 1.5 or more relative to air (e.g., PC=1.58 or PMMA=1.49), to create the desirable reflection and refraction properties. Other appropriate materials may include acrylics, methyl styrenes, acrylates, polypropylenes, polyvinyl chlorides, and the like. In some examples the material, dimensions, or both of wedge lightguide 104 may be selected in order to produce a semi-flexible lightguide.

Wedge lightguide 104 including, any surface structures, may be formed using any suitable technique. For example, wedge lightguide 104 may be made by molding, embossing, curing, or otherwise forming an injection moldable resin against a lathe-turned tool/die or other formed surface, made of metal or other durable material that bears a negative replica of the desired structured surface. Methods for making such formed surfaces and for molding, embossing, or curing the surface structures will be familiar to those skilled in the art.

In some examples, the structured surfaces (where present) of one or more of light-inlet side 112, light reflecting side 114, and display side 116 may be formed integrally with wedge lightguide 104. For example, wedge lightguide 104 may be formed using the techniques described above where the surface structures are formed using a negative mold or roller during the fabrication process of wedge lightguide 104 such that the body of wedge lightguide 104 and surface structures (e.g., wedge extractors 118) are integrally formed from the same material.

In other examples, the structured surfaces (where present) of one or more of light-inlet side 112, light reflecting side 114, and display side 116 may be formed as a polymer film optically coupled to a respective side of wedge lightguide 104. For example, the surface structures (e.g., wedge extractors 118) may be formed as an optical film and coupled to a blank of wedge lightguide 104 to form back side 114 using an optical adhesive. In other examples, an optical film coating may be extruded on a black of wedge lightguide 104 and passed through a die roller to form the surface structures (e.g., wedge extractors 118). In both cases, the optical adhesive and materials used to form the optical films should be selected to exhibit similar optical properties (e.g., substantially similar index of refractions) as the body of wedge lightguide 104 to reduce any reflection or refraction that may occur at the interface between the body of wedge lightguide 104 and the optical film material. In some such examples, the material used to form the structured surface may be the same as the material used to form the body of wedge lightguide 104.

In some examples, due to the optical properties of wedge lightguide 104 display system 100 may provide a relatively efficient transfer of light from light source 102 through display side 116 or wedge lightguide 104. In some examples, the extraction efficiency of display system 100 may be characterized based on the amount of light propagating within wedge lightguide 104 that exits through convergent side 126 (e.g., light lost due to optical inefficiencies or the lightguide design). In some examples, wedge lightguide 104 may exhibit an extraction efficiency such that less than 10% (e.g., less than 8%) of the light received through light-inlet side 112 is lost through convergent side 126.

Light source 102 may include any suitable light source or combination of light sources. For example, light source 102 may include an edge light assembly that includes one or more light emitting diodes (LEDs), cold cathode fluorescent lights (CCFLs), or incandescent light sources. Light source 102 may include a singular light source or may include a plurality of light sources (e.g., a light rail). For example, light source 102 may be a series or an array of LEDs extended along the z-axis into/out of the page of FIG. 1. In some examples, light source 102 may include a reflective housing configured to redirect light from produced via the light source (e.g., LED) to light-inlet side 112.

In some examples, light source 102 may be configured to emit substantially white light or may possess different components that each emit light of a different wavelength that may collectively recreate white light. “White” light may refer to any suitable desirable color point that may be perceived as a viewer as white light and may be adjusted or calibrated depending on the application of optical system 100. In some examples, light source 102 may emit light in one or more of the ultraviolet range, the visible range, or the near-infrared range of the electromagnetic spectrum. Light source 102 including any corresponding injection, collimation, and other optics may be selected to provide any suitable wavelength or combination of wavelengths, polarizations, point spread distributions, and degrees of collimation.

Light from light source 102 may be directed towards and coupled to the wedge lightguide 104 such that a majority of the light from light source 102 passes through light-inlet surface 112 of wedge lightguide 104 where it generally travels in the x-axis direction of within the lightguide 104.

In some examples, display system 100 may include other one or more optional optical films or devices 106 positioned between wedge lightguide 104 and display surface 108. For example, display system 100 may include an LCD assembly that includes, for example, brightness enhancement films, turning films, polarizers, privacy screens, protective screens, diffusers, LCD assemblies, reflectors, or the like. In some examples, display system 100 may include one or more absorption or reflective polarizer films that may be positioned either between wedge lightguide 104 and an LCD assembly or between the LCD assembly and display surface 108, or a combination of both. In such examples, the polarizer films may be used to enhance the contrast (e.g., absorption polarizer), brightness (e.g., reflective polarizer), visibility (e.g., in high glare environments), or a combination thereof of display system 100.

In some examples, display system 100 may include at least one turning film (e.g., optional optical films or devices 106) positioned to receive the exiting light rays from wedge lightguide 104. The turning film may be used to provide a useful or desirable output distributions of light by turning the light received from wedge lightguide 104 towards display surface 108 with a specified viewing/collimation angle. For example, the turning film may include a plurality of microstructures (e.g., prisms) that receive and reflect exiting light from wedge lightguide 104 towards normal 109.

In some examples, by using wedge lightguide 104 in conjunction with a distinct turning film, display system 100 may possess greater adaptability and versatility for use in specific applications compared to lightguides configured to substantially direct extracted light towards a display screen (e.g., outputted light that that would include rays parallel with normal 109). In some examples, the turning films may have a plurality of microstructures or prisms, each having at least a first and a second side (e.g., the faces of the prisms). In such examples, exiting light rays from display side 116 of wedge lightguide 104 may enter the turning film 106 through one side, except from Fresnel reflections that may occur at the at the interface, and them becomes reflected by the opposing side such that the light ray is effectively turned toward normal 109 within a specified collimation/viewing angle.

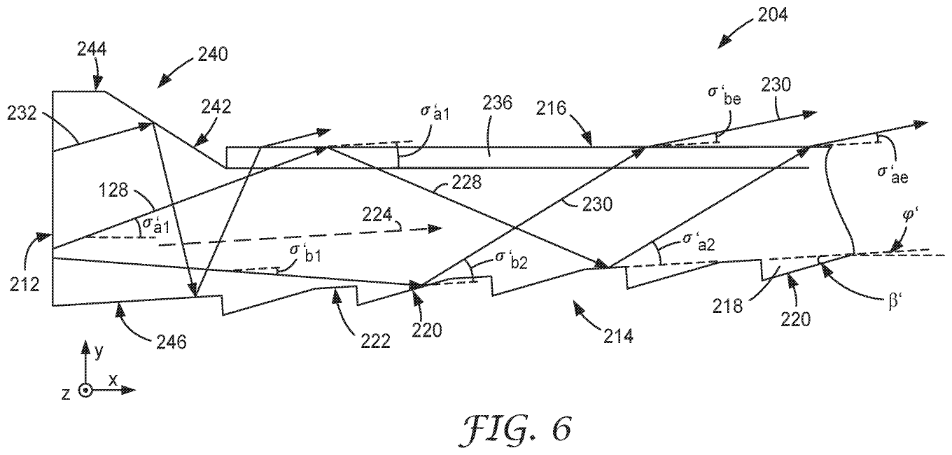

FIG. 5 is a schematic side elevation cross-sectional view of another example optical display system 200 that includes a light source 202, a wedge lightguide 204, as well as one or more optional optical films or devices 206. Optical display system 200 may define a display surface 208 having a normal 209 oriented towards a viewer 210. For ease of description, optical display system 200 and it various components are shown and described in referent to the x, y, and z-axes noted in FIG. 5 and used consistently throughout the FIGS. 5-7. One or more aspects of optical display system 200 may be the same or similar to those of optical display system 100 including, for examples, details regarding light source 202, optional optical films or devices 206, display surface 208, light reflector 233, coatings, and the like (unless otherwise indicated) with any differences indicated below.

Wedge lightguide 204 includes a light-inlet side 212, a back side 214, and a display side 216. Back side 214 may include plurality of wedge extractors 218 disposed across major surface 222, with each wedge extractor 218 defining an angled surface 220. Display side 216 may represent the side of wedge lightguide 204 generally facing display surface 208 while back side 214 may represent the side of wedge lightguide 204 generally facing away from display surface 208. Display side 216 may be characterized as the light-outlet side where the majority of the light entering through light-inlet side 212 will be transmitted out of wedge lightguide 204.

As with wedge lightguide 104, the orientation of a given side of wedge lightguide 204 may be characterized in terms of the plane defined by the side, regardless of the orientation or shape of any individual surface structure (e.g., prisms, wedges, lenticulars, diffusers, or the like) that may or may not be present on the respective side. The description of a given side facing, pointing, positioned, or oriented in a particular direction as used throughout the description refers to the orientation of the plane defined by the respective side rather that the orientation of any given optical structure on the respective side unless described otherwise. In some examples, display side 216 may be characterized as defining a plane that extends in x-z plane of FIG. 5 and faces in the y-axis direction (e.g., the normal of the plane defined by display side 216 points in the y-axis direction). Additionally, or alternatively, light-inlet side 212 may be characterized as defining a plane set substantially orthogonal (e.g., orthogonal or nearly orthogonal) to display surface 208, display side 216, or both.

In some examples, display side 216 may be characterized as defining a plane set substantially parallel (e.g., parallel or nearly parallel) to display surface 208 and back side 214 may be characterized as defining a plane that is offset from display surface 208 by a convergence angle (φ′) and facing away from display surface 208. In some examples, having display side 216 positioned substantially parallel to display surface 208 may help reduce the amount of exited light lost near convergent side 226. For example, in alternative arrangements where display side 216 is not positioned substantially parallel to display surface 208, the gap distance between display side 216 and any adjacent optional optical films or devices 206 may increase with further down-guide distance. Due to the relatively low angle of the exiting light from display side 216, an increased gap distance between display side 216 and any adjacent optional optical films or devices 206 may result an increase loss of light to the surroundings of optical display system 200. By keeping display side 216 substantially parallel to display surface 208, the gap distance may be substantially constant over the whole guide, thereby reducing the amount of light lost near convergent side 226.

Display side 216 and back side 214 may be positioned generally opposite of one another such that the two sides face in different directions of each other and aligned at a non-parallel, convergence angle (φ′) to one another such that the two sides form a wedge-shape. Convergence angle (φ′) may be substantially the same as convergence angle (φ) described above with respect to wedge lightguide 104. In some examples, the taper of the wedge-shape may also be characterized by the ratio of thicknesses between display side 216 and back side 214 measured at convergent side (D1) 226 and a portion adjacent to inlet-side coupler 240 (D2). In some examples the ratio of thicknesses (D1:D2) may be less than about 0.9, less than about 0.5, or less than about 0.25.

Wedge lightguide 204 may also be characterized by its convergence axis 224, which indicates the direction established by the taper between display and back sides 214 and 216 moving from the divergent side (e.g., light-inlet side 212) to the convergent side 226 of the wedge-shape, parallel to the plane defined by back side 214. In FIG. 5, convergence axis 224 is illustrated as being aligned parallel to back side 214 and at an angle of (φ′) to the x-axis in the x-y plane. Each wedge extractors 218 along back side 214 may extend in a direction substantially orthogonal (e.g., orthogonal or nearly orthogonal apart for minor misalignments (e.g., ±5°) resulting during the manufacturing process that do not significantly modify the optical characteristics of the wedge extractors) to convergence axis 224.

Optical system 200 may be configured such that light produced by light source 202 enters wedge lightguide 204 through light-inlet surface 212 where it propagates in the general direction of convergence axis 224.

Light-inlet side 112 may include an inlet-side coupler 240 configured to expand the collimation angle in the x-y plane of light entering light inlet-side 112. In the example shown in FIGS. 5-7, inlet-side coupler 240 is illustrated as a reflective prism having a tapered surface 242 spanning substantially perpendicular to convergent axis 224 (e.g., cross-guide) that reduces the relative thickness in the y-axis direction of light-inlet side 212 before reaching display side 216. In some examples, inlet-side coupler 240 may be characterized as having a linear surface 244 extending substantially perpendicular to light-inlet side 212 and tapered surface 242 extending from linear surface 244 to display side 216. In some examples, inlet-side coupler 240 may be configured to reflect the entering light that falls incident on tapered surface 242 such that the propagation angle of the reflected light (e.g., light ray 232) is sufficiently increased to allow the reflected light to exit through display side 216 near light source 202. By spreading light in such a way, a greater percentage of light may be passed through display side 216 near or adjacent to light source 202 to help ensure that a sufficient amount of light exits near light source 202 to provide a uniform distribution of exiting light over the entirety of display side 216. While inlet-side coupler 240 is illustrated in FIG. 5 a prism structure including tapered surface 242, other structures may also be used including, for example, a wedge, a funnel, a microstructure surface, or the like. In some examples, inlet-side coupler 240 may define light-inlet side 212, linear surface 244, tapered surface 242, and a portion of back side 214 (e.g., surface 246).

In some examples, light-inlet side 212 may also include a plurality of microstructures configured to spread or distribute light in the x-z plane as the light enters through light-inlet side 212. For example, light-inlet side 212 may include a plurality of microstructures (not shown) such as lenticular microstructures, prisms, or the like, aligned substantially vertically (e.g., aligned within ±5° of the y-axis of FIG. 5) to increase the distribution or spread of the light within the x-z plane propagating within wedge lightguide 204. In some examples, the microstructures may both disperse (e.g., spread along z-axis) as well as collimate the entering light within a desired collimation angle relative the plane defined by back side 214 (e.g., relative to the x-z plane).

In some examples, wedge lightguide 204 may define an index of refraction higher than the material directly adjacent to display side 216 (e.g., air or other optical film), thereby causing any light rays propagating within wedge lightguide 204 to either be reflected by the various sides of the lightguide or preferentially refracted by display side 216. In some examples, the parameters of the various surface structures of wedge lightguide 204 may be configured such that light exiting through display side 216 may be substantially collimated within a specified collimation exit angle that defines a maximum intensity exit angle (e.g., the point within the maximum intensity of the outputted light occurs) between about 10° and about 40° measured from the plane defined by display side 216 in the general direction of convergent axis 224 (e.g., the angle measured in the x-y plane with the x-axis representing 0° in FIG. 5). As described above, the bounds of the collimation exit angle may be determined as the point where the intensity of the exiting light rays diminishes to less than 10% of the maximum intensity. In some examples, the exit collimation angle and may be between about 0° (e.g., parallel to the x-axis in FIG. 5) to about 65° (e.g., a collimation angle between about 25° to about 90° relative to normal 209 of display surface 208 where 0° represents normal 209). In some examples, the peak intensity exit angle for light exiting display side 216 may be between about 10° and about 30° measured relative to the plane defined by display side 216 (e.g., between about 60° to about 80° relative to normal 209 of display surface 208 where 0° represents normal 209). In some examples, the exiting light rays may be substantially collimated within an angle of less than about ±25°.

In some examples, the majority of extracted light exiting through display side 216 may be outputted within a specified exit collimation angle of about 0° to about 65° measured from the plane of display side 216 aligned relative to convergence axis 224. In some examples, the boundaries of the range of the exit collimation angle may be defined at the point where the intensity diminishes to less than about 10% of the maximum intensity.

As described above with respect to wedge lightguide 104 of FIG. 1, whether a given light ray within the wedge lightguide will be reflected or refracted by a given side will depended on the angle of propagation (σ′) for the light ray. FIG. 6 provides an enlarged schematic cross-sectional view of wedge lightguide 204 demonstrating some of the operational and optical principles of wedge lightguide 204. As shown in FIG. 6, light rays 228, 230, and 232 may be produced by light source 202 and introduced into wedge lightguide 204 through light-inlet side 212. Light rays 228, 230, and 232 pass through light-inlet side 212 where light rays 228, 230 progress into the body of wedge lightguide 204 (e.g., the region between back and display sides 214 and 216) with an initial propagation angle of σ′ₐ₁ and σ′_{b1} respectively, while light ray 232 interacts with the reflective surface of inlet-side coupler 240. Light ray 232 reflects off inlet-side coupler 240 at a much higher propagation angle and exits through display side 216 substantially up-guide (e.g., adjacent to inlet-side coupler 240).

The initial propagation angles σ′ₐ₁ and σ′_{b1}, as well as the other propagation angles and/or exit angles within wedge lightguide 204 may be measured in reference to the x-y plane of FIG. 6 relative to convergence axis 224 (e.g., in the plane established between convergence axis 224 and normal 209) where convergence axis 224 is taken as 0°. For ease of understanding, the propagation angles of the respective light rays 228, and 230 are described in terms of their absolute values relative to convergence axis 224.

Due to the optical properties of wedge lightguide 204 and display system 200, light rays propagating within wedge lightguide 204 will be substantially reflected by display side 216 and back side 214, provided the propagation angle of the light ray is below some specified threshold angle (σ′ₜ). Light rays exceeding the threshold angle (σ′ₜ) that become incident on display side 216 will be substantially refracted, rather than reflected, and exit display side 216 at an exit angle (e.g., σ′ₐₑ and σ′_{be}).

As described previously, the propagation angle (σ′) of the light rays propagating within wedge lightguide 204 will progressively increase depending on the surface reflecting the light ray or the number of reflections that occur. The progression of propagating light rays 228 and 230 within wedge lightguide 204 may behave substantially similar to the propagation of light rays 128 and 130 within wedge lightguide 104 except for any differences described herein and therefore will not be repeated below.

In some examples, lightguide 204 may be relatively thick (e.g., greater than 1.5 mm). To improve the extraction efficiency for light exiting through display side 216, particularly light exiting down-guide or closer to convergent side 226, back side 214 may include a plurality of wedge extractors 218 that each include a respective angled surface 220 configured to both reflect propagating light rays as well as increase the propagation angle (σ′) of the reflected ray. Wedge extractors 218 may take on any suitable shape and design and may be substantially similar to wedge extractors 118 described above. In some examples, wedge extractors 218 define at least one angled surface 220 that operates as the primary reflective surface and defines an internal angle β′ relative the plane defined by back side 214 (e.g., relative to major surface 222). The internal angle β ′ may be established by the side of angled surface 220 opposite of light source 202 and light-inlet side 212 (e.g., the side further down-guide). Internal angle β ′ may be set so that light rays reflected by angled surface 220 are redirected toward display side 216 possessing an increased propagation angle (σ′), which may be sufficient to allow the reflected light ray to be at least partially refracted and exit wedge lightguide 204 within a specified exit collimation angle. In some examples, the internal angle β ′ of wedge extractors 218 may be greater than 0°, but less than about 10° measured relative to the plane defined by back side 214 or major surface 222, where the internal angle β ′ represents the side of angled surface 220 further from light source 202 (e.g., the side more down-guide in the x-axis direction). Angled surface 220 may be planer, curved, undulated, segmented, or a combination thereof. In some examples, wedge extractors 218 may described as discrete prisms (e.g., microprisms) on back side 214 or may have be established by an undulated pattern (e.g., a surface creating an undulated saw-toothed or sinusoidal pattern) imprinted across back side 214.

In some examples, having relatively low angle extractors, compared to higher angle extractors (e.g., those with an internal angle β ′ greater than 10°) may help lower the down-guide angular distributions of the exiting light rays allowing the exiting light to maintain a relatively uniform collimation angle. The uniform collimation of exiting light rays the may be particularly useful in display systems that further process the exiting light (e.g., via a subsequent turning film or the like) where the collimation may be needed to maintain uniform brightness or to allow the turning film (e.g., film 206) to function efficiently. In some examples, the internal angle β ′ may be between about 0.5° to about 10°, between about 1° to about 8°, or between about 1° to about 5°.

In some examples, the internal angle β ′ of wedge extractors 218 may define an angle gradient in the direction of convergence axis 224 (moving distal or down-guide) similar to the gradient described above with respect to wedge lightguide 104. Such a configuration may provide a more uniform exit collimation angle of light exiting across display side 216 as well as a greater extraction efficiency further down-guide.

Additionally, or alternatively, the size and placement of wedge extractors 218 may be selectively varied over back side 214 to enhance the extraction efficiency of propagating light rays down-guide. An increased presence of wedge extractors 218 within these distal regions may help increase the efficiency of light extracted through display side 216 within these distal regions by increasing the propagation angle (σ′) of the reflected light such that it can be substantially refracted and exit through display side 216.

In some examples, to improve the disbursement of light within the lateral direction (e.g., within the y-z plane), display side 216 may itself be a structured surface. Display side 216 may include a plurality of microstructure 236 such as lenticular microstructures, configured to increase the lateral collimation angle (e.g., angle relative to the y-z plane of FIG. 6) of the light rays exiting thorough display side 216. Lenticular microstructures 236 may be generally aligned with respect to convergence axis 224 such that the microstructures extend along display side 216 from inlet-side coupler 240 to convergent side 226. In some examples, plurality of lenticular microstructures 236 may be offset by about ±10° relative to convergence axis 224 where 0° represents a parallel alignment with convergence axis 224.

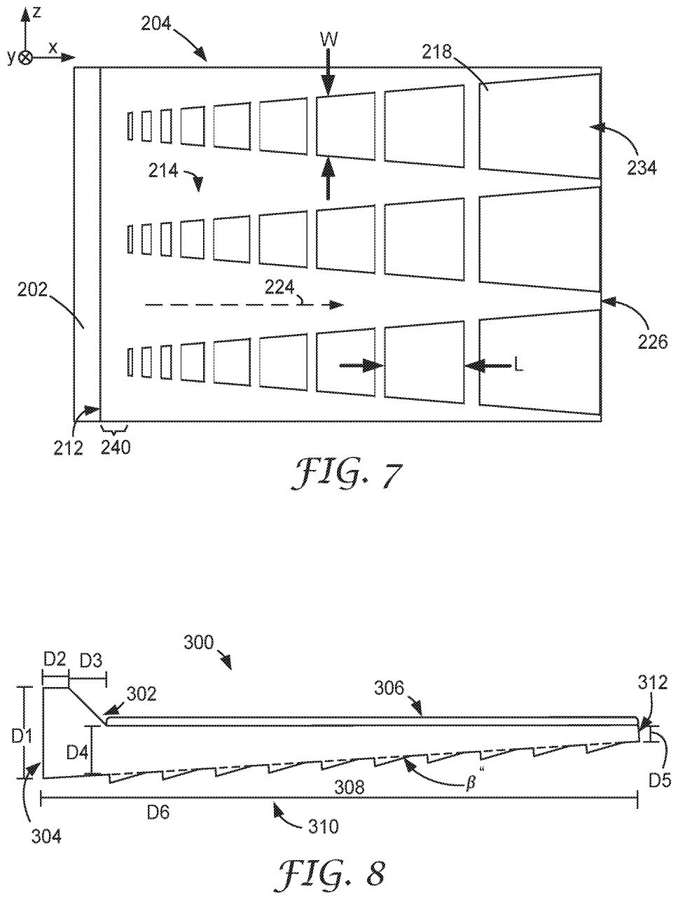

FIG. 7 illustrates one non-limiting example of how wedge extractors 218 may be distributed across back side 214. FIG. 7 is a schematic bottom view of wedge lightguide 204 assembled adjacent to light source 202 (e.g., similar arrangement to display system 200). Wedge extractors 218 may be arranged in one or more groupings 234 that extend from the proximal region (e.g., adjacent light-inlet side 212) to the distal region (e.g., adjacent convergent side 226) of back side 214. Each wedge extractor 218 within a group 234 may define a width (W) between about 5 μm to about 400 μm (e.g., about 10 μm to about 150 μm). In some examples, the widths of wedge extractors 218 within a respective group 234 may be different such that wedge extractors 218 within the proximal region of the wedge lightguide 204 (e.g., closer to light-inlet side 212) possess a smaller width compared to wedge extractors 218 within the distal region of the wedge lightguide 204 (e.g., closer to convergent side 226). In some such examples, wedge extractors 218 within a given grouping 234 may define a range of widths or one or more gradients such that the width from of adjacent wedge extractors 218 increases (e.g., continuously or step-wise increase) the more distal (e.g., down-guide) a given wedge extractor 218 is from light-inlet side 212.

Additionally, or alternatively, the respective down-guide lengths (L) (not drawn to scale) of wedge extractors 218 as measured in the direction of convergence axis 224, may increase within a respective grouping 234 the further a wedge extractor 218 is from light-inlet side 212. In some examples, the length (L) of wedge extractors 218 may be adjusted by increasing the height/depth of a give wedge extractor 218 from major surface 222 measured relative to the y-axis direction) moving distal (e.g., down-guide) from light inlet-side 212. In some such examples, wedge extractors 218 within a given grouping 234 may define a range of depths that extends from about 0.5 μm to about 10 μm. Additionally, or alternatively, the range of depths may define a depth gradient such that the respective depths of wedge extractors 218 increase (e.g., continuously or step-wise increase) the more distal (e.g., down-guide) a given wedge extractor 218 is from light-inlet side 212. In some example, the respective surface areas of angled surfaces 220 may increase (increasing in width, length, or both) the more distal (e.g., down-guide) a given wedge extractor 218 is from light-inlet side 212. The number of groups 234 of wedge extractors 218 may be selected to provide the desired optical properties for wedge lightguide 204. In some examples, the uniformity and disbursement of the light extracted through display side 216 may be improved by including more groups 234 of wedge extractors 218 (e.g., about 25 to about 200 groups per centimeter).

Display system 200 may include other one or more optional optical films or devices 206 positioned between wedge lightguide 204 and display surface 208. In some examples, display system 200 may include at least one turning film (e.g., optional optical films or devices 206) positioned to receive the exiting light rays from wedge lightguide 204. The turning film may be used to provide a useful or desirable output distributions of light by turning the light received from wedge lightguide 204 towards display surface 208 with a specified viewing/collimation angle. In some examples, optional film or device 206 (e.g., a turning film) may be positioned adjacent and substantially parallel (e.g., within substantially the same plane) to display side 216. In some examples, such as in automotive displays, optional film or device 206 may be separated from display side 216 by an air gap to avoid potential damage to either surface due to vibrations. In other examples, optional film or device 206 and display side 216 may mechanically and optically coupled together (e.g., via an optical adhesive).

In some examples, due to the optical properties of wedge lightguides 104 and 204 may provide a relatively efficient transfer of light from light source 102, 202 through display side 116, 216. For example, the combination of the wedge-shape of wedge lightguide 204, wedge extractors 218, and inlet-side coupler 240 may provide a greater extraction efficiency and improved distribution for transmitting light through display side 216 uniformly and within a desired collimation angle. The combination of features may be particularly useful for certain types of applications, such as automotive displays, that utilize or require relatively thick lightguides (e.g., greater than 1.5 mm such as about 2 mm to about 3 mm), which may otherwise suffer from decreased extraction efficiency due to the relative thickness of the lightguides. In some examples, the extraction efficiency of wedge lightguides 104 and 204 may be characterized based on the amount of light propagating within the wedge lightguide that exits through convergent side 126 or 226 (e.g., light lost due to optical inefficiencies or the lightguide design). In some examples, wedge lightguides 104 and 204 may exhibit an extraction efficiency such that less than 10% (e.g., less than 7%) of the light received through light-inlet side 112 or 212 is lost through convergent side 126 or 226.

### EXAMPLES

A digital model of a wedge lightguide system similar to wedge lightguide 204 was constructed in a commercial optical modeling program called LightTools (a product of Synopsis). FIG. 8 is a cross-sectional view of the modeled wedge light 300 used in the modeling program that defines the various dimensions of the components used in the modeling. Wedge lightguide 300 included an injection edge thickness (D1 e.g., thickness of light-inlet side 212) of 2 mm, a inlet-side coupler that included a flat length (D2) of 1 mm, and a taper length (D3) of 4.81 mm, and a guide starting thickness (D4) of 1.516 mm. The thickness of the convergent side (D5) was 0.3 mm which is consistent with many edge finishing processes. The optical properties of wedge lightguide 300 was compared to a plane lightguide having a thickness of 1.516 mm and comparable inlet-side coupler 302.

The light inlet side 304 of modeled wedge lightguide 300 was assumed to have a Gaussian scattering distribution with a standard deviation of 10 degrees. Display side 306 included a lenticular surface with a 100% duty cycle. The radius of the lenticulars were 0.046 mm with a period of 0.034 mm. Wedge extractors 308 were placed on the back side 310. Wedge extractors 308 were asymmetric and had a leading edge (213) (the side nearest the light-inlet side 304) base angle of 60°. The angled surfaces of wedge extractors 308 were tested at various internal angles (e.g., β″) including 1°, 2°, 4°, and 8°. The minimum extractor separation of wedge extractors 308 was 0.0075 mm. The down-guide extractor period of wedge extractors 308 was 0.075 mm and the base length of each extractor was the same. In the cross-guide direction, the mean wedge extractor 308 spacing was 0.075 mm. The wedge extractors 308 were initiated at 7.43 mm from the light inlet side 304.

The width of wedge lightguide 300 was set at 300 mm and the guide length (D6) was set at 120 mm. The model also included a reflector positioned adjacent to back side 310. The reflector was assumed to be 99% reflective. A symmetric turning film of 58° base angle was modeled over wedge lightguide 300 to turn exiting light towards the normal of display side 306. Both the reflector and the turning film were modeled to have be the same size as the respective back and display sides 310 and 306. The turning film and wedge lightguide 300 were assumed to have a refractive index of 1.587 and an extinction coefficient of 3.7E-8 at 550 nm. The modeling was all done for 550 nm light rays.

The light source was assumed to be an array of 30 LEDs evenly spaced along light-inlet side 304. Light detection was measured in air above the turning film and on the distil end (e.g., convergent side 312). The distil detector collected the light exiting from inside the light-guide into air only.

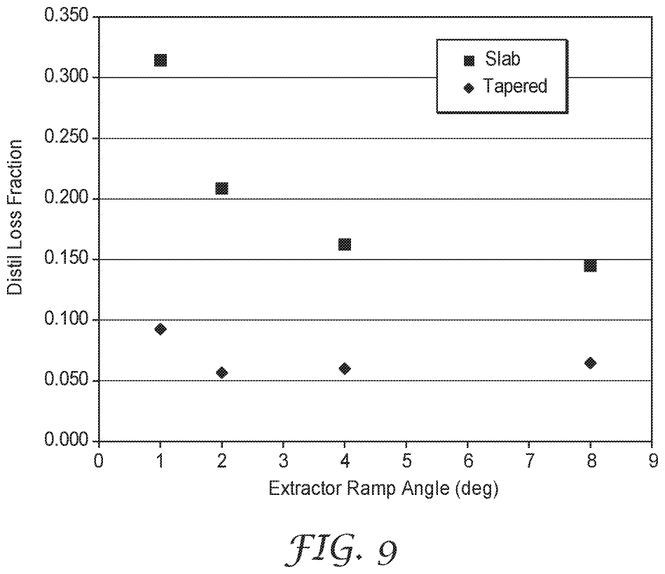

FIG. 9 shows the distil loss fraction of wedge lightguide 300 compared to a comparable plane lightguide for wedge extractors 308 modeled at various ramp internal angles (e.g., β″). Results showed that the wedge design has much lower distil loss, and much higher efficiency. They also demonstrated less distil light being reflected. All plane lightguide designs have fractional distil losses of greater than 10% while all wedge lightguide designs have fractional distil losses of less than 10%.

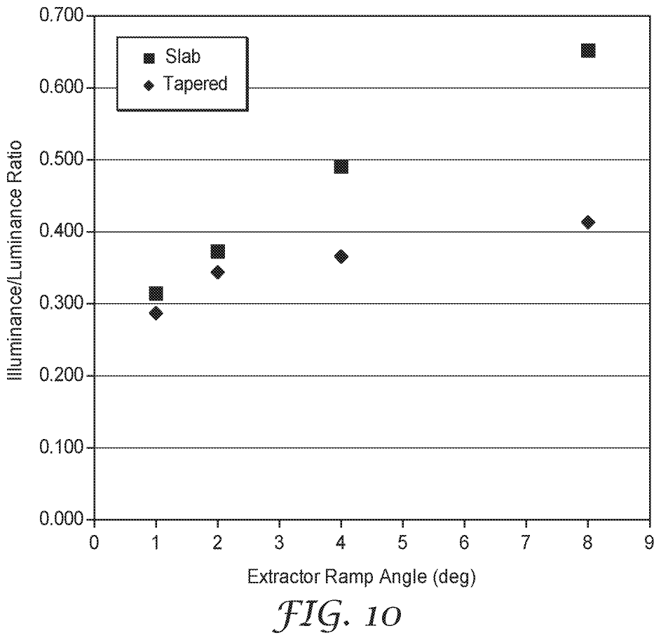

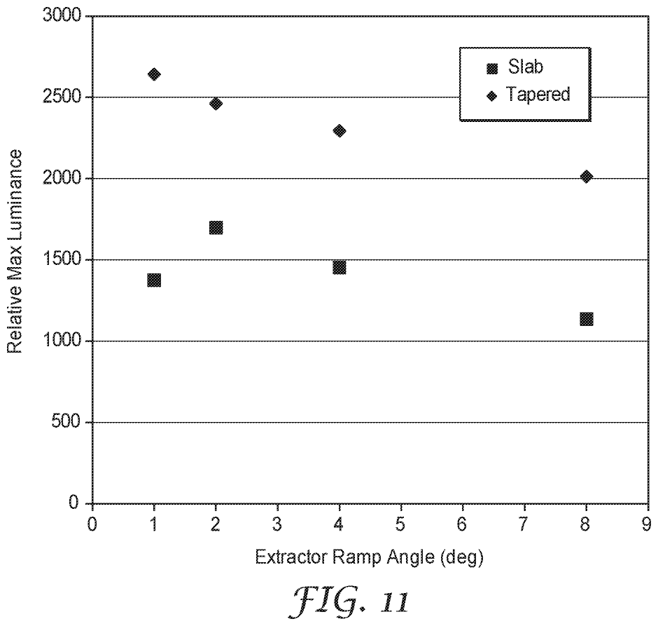

FIG. 10 shows a ratio of the illuminance to maximum luminance of wedge lightguide 300 compared to a comparable plane lightguide for wedge extractors 308 modeled at various ramp internal angles (e.g., β″). The results demonstrated that wedge lightguide 300 exhibited greater extraction efficiency, less distil loss, and better collimation of exiting light that the plane lightguides. The data indicated that wedge lightguide 300 exhibited possess higher peak brightness values.

FIG. 11 shows the relative brightness values for wedge lightguide 300 compared to a comparable plane lightguide for wedge extractors 308 modeled at various ramp internal angles (e.g., β″).

Various examples have been described. These and other examples are within the scope of the following claims.

1. A display device comprising:
a wedge lightguide defining a light-inlet side, a display side, and a back side, the display and back sides facing in different directions of each other to form a wedge-shape that defines a convergence axis, wherein the light-inlet side is positioned at a divergent side of the wedge-shape and the back side facing away from a display surface of the display device, wherein the back side comprises a plurality of wedge extractors, and wherein each wedge extractor of the plurality of wedge extractors extends in a direction substantially orthogonal to the convergence axis; and
a light source positioned adjacent to the light-inlet side of the wedge lightguide, wherein the wedge lightguide is configured to receive light rays from the light source through the light-inlet side and transmit the light rays through the display side, wherein the light rays transmitted through the display side define a maximum intensity at an exit angle between about 10° and about 40° measured from a plane defined by the display side.

2. The display device of claim 1, wherein each wedge extractor of the plurality of wedge extractors comprises an angled surface that defines an internal angle opposite the light-inlet side, wherein the angled surface is configured to reflect light rays propagating within the wedge lightguide toward the display side, and wherein the internal angle is less than about 10°.

3. The display device of claim 2, wherein the internal angle defines an angle between a plane defined by the back side and a plane defined by the angled surface.

4. The display device of claim 2, wherein the angled surfaces of the plurality of wedge extractors each define a surface area, wherein the surface areas of the angled surfaces increase the more distal the angled surface is from the light-inlet side.

5. The display device of claim 1, wherein the internal angle of the plurality of wedge extractors increase the more distal the angled surface is from the light-inlet side.

6. The display device of claim 2, wherein the internal angles of the plurality of wedge extractors are substantially the same, wherein each wedge extractor of the plurality of wedge extractors defines a depth measured as a maximum distance between a major surface of the back side and the wedge exactor in a direction substantially orthogonal to the major surface, and wherein the depths of the plurality of wedge extractors increase the more distal the wedge extractor is from the light-inlet side.

7. The display device of claim 1, wherein each wedge extractor of the plurality of wedge extractors defines a width measured in a direction substantially orthogonal to the convergence axis, wherein the widths of the plurality of wedge extractors increase the more distal the wedge extractor is from the light-inlet side.

8. The display device of claim 1, wherein the plurality of wedge extractors comprises:
a first wedge extractor defining a first width measured in a direction substantially orthogonal to the convergence axis; and
a second wedge extractor defining a second width greater than the first width, measured in a direction substantially orthogonal to the convergence axis, wherein the first wedge extractor is positioned closer to the light-inlet side than the second wedge extractor.

9. The display device of claim 8, wherein the first wedge extractor comprises a first angled surface defining a first area and the second wedge extractor comprises a second angled surface defining a second area greater than the first area.

10. The display device of claim 8, wherein the first wedge extractor defines a first internal angle and the second wedge extractor defines a second internal angle greater than the first internal angle, wherein an internal angle defines an angle between a plane defined by the back side and a plane defined by an angled surface of a wedge extractor.

11. The display device of claim 1, wherein display side comprises a plurality of lenticular microstructures extending in a direction substantially parallel to the convergence axis.

12. The display device of claim 1, further comprising a turning film comprising a plurality of microstructures positioned between the display surface and the display side of the wedge lightguide, wherein the turning film receives the light rays exiting the display side of the wedge lightguide and redirects the light rays towards the display surface.

13. The display device of claim 1, wherein the light-inlet side comprises a plurality of microstructures configured to spread light rays received from the light source within a plane parallel to a plane defined by the back side.

14. The display device of claim 1, wherein the wedge lightguide further comprises an inlet-side coupler defining the light-inlet side, wherein the inlet-side coupler is configured to increase a collimation angle of light entering through the light-inlet side before the light passes between the display side and back side.

15. The display device of claim 14, wherein the inlet-side coupler comprises a prism extending perpendicular to the convergent axis.

16. The display device of claim 1, wherein the light rays exiting the display side are substantially collimated within a collimation angle between about ±25°, wherein the collimation angle represents a range where an intensity of the light rays exiting from the display side is at least 10% of the maximum intensity.

17. The display device of claim 1, wherein the light rays exiting the display side are substantially collimated within a collimated exit angle between about 0° and about 50° measured from a plane defined by the back side and aligned relative to the convergent axis.

18. The display device of claim 1, wherein the wedge lightguide defines a thickness between the display side and the back side of at least 1.5 mm.

19. The display device of claim 1, wherein the wedge lightguide further comprises a convergent side opposite the light-inlet side, wherein less than 10% of the light rays entering through the light-inlet side exit through the convergent side.

20. The display device of claim 19, wherein less than 7% of the light rays entering through the light-inlet side exit through the convergent side.

21. The display device of claim 1, wherein the back side is aligned substantially parallel to the display surface.

22. The display device of claim 1, wherein the display side is aligned substantially parallel to the display surface.

23. A wedge lightguide comprising:
a light-inlet side defining a divergent side of the wedge lightguide;
a convergent side opposite of the light-inlet side;
a display side aligned substantially orthogonal to the light-inlet side; and
a back side, wherein the display and back sides face in different directions of each other to form a wedge-shape that defines a convergence axis with the light-inlet side and the convergent side at opposite ends of the wedge-shape, wherein the back side comprises a plurality of wedge extractors, and wherein each wedge extractor extends in a direction substantially orthogonal to the convergence axis,
wherein the wedge lightguide is configured to receive light rays from a light source through the light-inlet side and transmit the light rays through the display side, wherein the light rays transmitted through the display side define a maximum intensity at an exit angle between about 10° and about 40° measured from a plane defined by the display side.

24. The wedge lightguide of claim 23, wherein each wedge extractor of the plurality of wedge extractors comprises an angled surface that defines an internal angle opposite the light-inlet side, wherein the angled surface is configured to reflect light rays propagating within the wedge lightguide toward the display side, and wherein the internal angle is less than about 10°.

25. The wedge lightguide of claim 24, wherein the internal angle defines an angle between a plane defined by the back side and a plane defined by the angled surface.

26. The wedge lightguide of claim 24, wherein the angled surfaces of the plurality of wedge extractors each define a surface area, wherein the surface areas of the angled surfaces increase the more distal the angled surface is from the light-inlet side.

27. The wedge lightguide of claim 24, wherein the internal angle of the plurality of wedge extractors increase the more distal the angled surface is from the light-inlet side.

28. The wedge lightguide of claim 24, wherein the internal angles of the plurality of wedge extractors are substantially the same, wherein each wedge extractor of the plurality of wedge extractors defines a depth measured as a maximum distance between a major surface of the back side and the wedge exactor in a direction substantially orthogonal to the major surface, and wherein the depths of the plurality of wedge extractors increase the more distal the wedge extractor is from the light-inlet side.

29. The wedge lightguide of claim 23, wherein each wedge extractor of the plurality of wedge extractors defines a width measured in a direction substantially orthogonal to the convergence axis, wherein the widths of the plurality of wedge extractors increase the more distal the wedge extractor is from the light-inlet side.

30. The wedge lightguide of claim 23, wherein the plurality of wedge extractors comprises:
a first wedge extractor defining a first width measured in a direction substantially orthogonal to the convergence axis; and
a second wedge extractor defining a second width greater than the first width, measured in a direction substantially orthogonal to the convergence axis, wherein the first wedge extractor is positioned closer to the light-inlet side than the second wedge extractor.

31. The wedge lightguide of claim 30, wherein the first wedge extractor comprises a first angled surface defining a first area and the second wedge extractor comprises a second angled surface defining a second area greater than the first area.

32. The wedge lightguide of claim 30, wherein the first wedge extractor defines a first internal angle and the second wedge extractor defines a second internal angle greater than the first internal angle, wherein an internal angle defines an angle between a plane defined by the back side and a plane defined by an angled surface of a wedge extractor.

33. The wedge lightguide of claim 23, wherein display side comprises a plurality of lenticular microstructures extending in a direction substantially parallel to the convergence axis.

34. The wedge lightguide of claim 23, wherein the light-inlet side comprises a plurality of microstructures configured to spread light rays received through the light-inlet side within a plane parallel to a plane defined by the back side.

35. The wedge lightguide of claim 23, further comprising an inlet-side coupler defining the light-inlet side, wherein the inlet-side coupler is configured to increase a collimation angle of light entering through the light-inlet side before the light passes between the display side and back side.

36. The wedge lightguide of claim 35, wherein the inlet-side coupler comprises a prism extending perpendicular to the convergent axis.

37. The wedge lightguide of claim 23, wherein the light rays exiting the display side are substantially collimated within a collimated exit angle between about 0° and about 50° measured from a plane defined by the back side and aligned relative to the convergent axis.

38. The wedge lightguide of claim 23, wherein the wedge lightguide defines a thickness between the display side and the back side of at least 1.5 mm.

39. The wedge lightguide of claim 23, wherein less than 10% of the light rays entering through the light-inlet side exit through the convergent side.

40. A wedge lightguide comprising:
an inlet-side coupler defining the light-inlet side defining a divergent side of the wedge lightguide, wherein the inlet-side coupler is configured to increase a collimation angle of light entering through the light-inlet side;
a convergent side opposite of the light-inlet side;
a display side aligned substantially orthogonal to the light-inlet side and adjacent to the inlet side coupler; and
a back side, wherein the display and back sides face in different directions of each other to form a wedge-shape that defines a convergence axis with the light-inlet side and the convergent side at opposite ends of the wedge-shape, wherein the back side comprises a plurality of wedge extractors, and wherein each wedge extractor extends in a direction substantially orthogonal to the convergence axis, and wherein each wedge extractor of the plurality of wedge extractors comprises an angled surface that defines an internal angle opposite the light-inlet side, wherein the internal angle is less than about 10°,
wherein the wedge lightguide is configured to receive light rays from a light source through the light-inlet side and transmit the light rays through the display side, wherein the light rays transmitted through the display side define a maximum intensity at an exit angle between about 10° and about 40° measured from a plane defined by the display side.

41. The wedge lightguide of claim 40, wherein the wedge lightguide defines a thickness between the display side and the back side of at least 1.5 mm.

42. The wedge lightguide of claim 40, wherein less than 10% of the light rays entering through the light-inlet side exit through the convergent side.
